(19) United States
(12) Patent Application Publication
(10) Pub. No.: US 2004/0048659 A1
(43) Pub. Date: Mar. 11, 2004

(54) Gaming device and method

(75) Inventors: Jerald C. Seelig, Absecon, NJ (US); Lawrence M. Henshaw, Hammonton, NJ (US)

Correspondence Address: IAN F. BURNS & ASSOCIATES, 1575 DELUCCHI LANE, SUITE 222, RENO, NV, 89502, US

(73) Assignee: Atlantic City Coin & Slot Service Company, Inc., Pleasantville, NJ

(21) Appl. No.: 10/655,821

(22) Filed: Sep. 4, 2003

Related U.S. Application Data
(60) Provisional application No. 60/408,293, filed on Sep. 4, 2002.

(51) Int. Cl. A63F 13/00

(52) U.S. Cl. 463/25

(57) ABSTRACT

In one embodiment, the present invention is directed to a gaming device. The gaming device may include a random number generator. A skill game device may also be included. The skill game device is configured to allow a game player to play a skill game having a skill game outcome. The skill game outcome is influenced by the skill of the game player and the skill game outcome may be displayed to the player. The gaming device may also include a processor in communication with the random number generator. The processor may be configured to randomly determine a prize and to calculate a multiplier that may be the quotient of the prize divided by the skill game outcome. The gaming device may also include a display in communication with the processor and the skill game device. The display may be adapted to show both the prize and the multiplier.

### BACKGROUND OF THE INVENTION

1. Field of Invention

The present invention relates to a gaming device that appears to allow game players to use their skill to influence the outcome of a skill game portion of the game, while the overall game result is randomly determined.

2. Background

Gaming Devices

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number (hereinafter collectively referred to as “random numbers”). The random number may then be used to determine a game outcome. For example, the random number may be compared to a predefined table to determine the outcome of the event. If the random number falls within a certain range of numbers on the table, the player may win a prize. The table may also contain display information that allows the gaming device to generate a display that corresponds to the outcome of the game. The gaming device may present the outcome of the game on a large variety of display devices, such as mechanical spinning reels, spinning wheels, or video screens.

Bonus Prizes

Some gaming devices award bonuses in addition to prizes that are awarded in a primary game. A bonus can be defined as an additional prize, or a chance to win a prize (for example, the chance to play a bonus game may be a prize awarded by a primary game), that is awarded to the player when a predefined event occurs. An example of a bonus game can be found in U.S. Pat. No. 5,848,932 to Adams. One of the gaming devices described in Adams comprises three spinning reels and a spinning wheel bonus display. When predetermined indicia are displayed on the spinning reels of the primary game, the wheel can be activated to indicate the result of the bonus game. The bonus prize is awarded in addition to any prizes awarded in the primary game.

Generally, bonus prizes are offered in such games in order to increase the excitement and enjoyment experienced by players. This attracts more players to the game and encourages players to play longer. When gaming devices attract more players and the players play longer, and they may generate more revenue for a game operator. Such games tend to be more commercially successful relative to other gaming devices.

Display Devices

In addition, highly visible display devices are utilized on gaming devices in order to attract players. Once players are attracted to the gaming device, they tend to play longer because the display device enhances the stimulation and excitement experienced by players. It is, therefore, desirable for gaming devices to incorporate highly visible display devices.

Display devices may be more successful if they are a derivation of a well-known game or theme. They are more successful because players tend to be drawn to games that they instantly recognize. Many players are reluctant to try completely new games because they must spend time to learn the new game. It is, therefore, desirable to provide display devices that are based on well-known games or themes.

Display devices also tend to be more successful if they utilize physical objects rather than simulations. Although video devices and electronic signs can be used for display devices, players are more attracted to display devices that utilize physical objects. Physical objects can be even more effective display devices if they are moveable and they are used in combination with lights and sounds.

Skill Games

Skill games are an excellent choice for gaming devices. Skill games are games in which the outcome of the game is influenced by the actions of the game player in some manner. A goal, task, or objective for a game is accomplished in a manner such that an outcome of the game is determined at least to some extent by the amount of skill of the player. The greater the player's skill, the closer or more easily a desired goal in the game can be reached by the player. Points associated with the goals or objectives can be added to a game score such that a higher game score indicates a greater amount of skill by the player. For example, a displayed object can be manipulated, picked-up, or directed using an input device such as a joystick, keyboard, keypad, mouse, button, or steering wheel. The outcome of the skill game may depend on the knowledge, dexterity, reaction time, or hand-eye coordination of the player. Skill games tend to be entertaining to players, hold player interest, and have highly visible displays. Game players are attracted to skill games because they like the challenge the game presents and because they receive recognition for their skill. Game players are attracted to skill games because they perceive an opportunity to influence the game outcome.

However, before the present invention, skill games have been unsuitable for use in casino gaming environments. Most state jurisdictions within the United States mandate by law that the outcome of a gaming device cannot be influenced by the game player. These laws were designed to insure that all game winnings are generated randomly and are free from outside interference, influence, and tampering.

Another reason that skill games have been unsuitable for use as a gaming device is that may require a great deal of human involvement. In many skill games, human operators are required to read the numbers on balls as they are selected or count the occurrence of some event. This requires too much human involvement for an automated gaming device, which adds cost to operate the game. The addition of human operators also makes skill games more susceptible to tampering and cheating by the operator.

What has long been needed is a gaming device that appears to allow the game player to use his or her skill to influence the outcome of the game, while at the same time having an overall game outcome that is truly random. Another long felt need is for a gaming device that allows the game player to use skill without the need for a human operator.

### SUMMARY OF INVENTION

Advantages of the Invention

The various embodiments of the present invention may, but do not necessarily, achieve one or more of the following advantages:

provide a gaming device that gives game players the illusion that they are influencing the outcome of the game;

provide a gaming device that allows game players to use their skill to at least partially influence a skill game outcome;

provide a gaming device that utilizes an input device that allows a game player to manipulate an object to influence a skill game outcome;

provide a gaming device that utilizes a sensor to sense a game outcome;

provide a gaming device that calculates a multiplier and displays the multiplier to the game player, the multiplier being a function of a randomly selected prize and an outcome at least partially based on a player's skill;

provide a gaming device that can be used as a primary game or a bonus game;

provide a gaming device that is challenging, attractive, and entertaining to a game player;

provide a gaming device that may be configured to require no human operators; and

provide a gaming device that allows a player to at least partially influence a skill game outcome while awarding a randomly generated prize.

These and other advantages of the present invention may be realized by reference to other portions of the specification, claims, and abstract.

### BRIEF DESCRIPTIONS OF THE INVENTION

In at least one embodiment, the present invention is directed to a gaming device. The gaming device may include a random number generator. A skill game device may also be included. The skill game device is configured to allow a game player to play a skill game having a skill game outcome. The skill game outcome is influenced by the skill of the game player and the skill game outcome may be displayed to the player.

The gaming device may also include a processor in communication with the random number generator. The processor may be configured to randomly determine a prize and to calculate a multiplier. The multiplier may be the quotient of the prize divided by the skill game outcome.

The gaming device may also include a display in communication with the processor and the skill game device. The display may be adapted to show both the prize and the multiplier.

In another embodiment, the present invention is directed to a method of playing a game. The method may comprise determining a prize and allowing a player to use skill to determine a skill game outcome. The prize may be divided by the skill game outcome to determine a multiplier. The multiplier may be displayed to the player. The prize may be awarded to the player such that the prize appears to be the product of the skill game outcome and the multiplier.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Preferred embodiments of the present invention are shown in the accompanying drawings wherein:

FIG. 1a is substantially a front view of an embodiment of a gaming device of the present invention.

FIG. 1b is substantially a front view of another embodiment of a gaming device of the present invention.

FIG. 2 is substantially a front view of a gaming device of the present invention.

FIG. 3 is substantially a front view of an alternative embodiment of a gaming device of the present invention.

FIG. 4 is substantially a front view of another embodiment of a gaming device of the present invention.

FIG. 5 is substantially a front view of an alternative embodiment of a gaming device of the present invention.

FIG. 6 is substantially a front view of a gaming device of the present invention utilizing a video display device.

FIG. 7 is substantially a schematic diagram of a gaming device of the present invention.

FIG. 8 is substantially a flow chart of the operation of a gaming device of the present invention.

FIG. 9 is substantially a front view of a gaming device of the present invention when used as a bonus game.

FIG. 10 is substantially a flow chart of the operation of the bonus game embodiment of FIG. 9.

### DESCRIPTION OF CERTAIN EMBODIMENTS OF THE INVENTION

Gaming Device

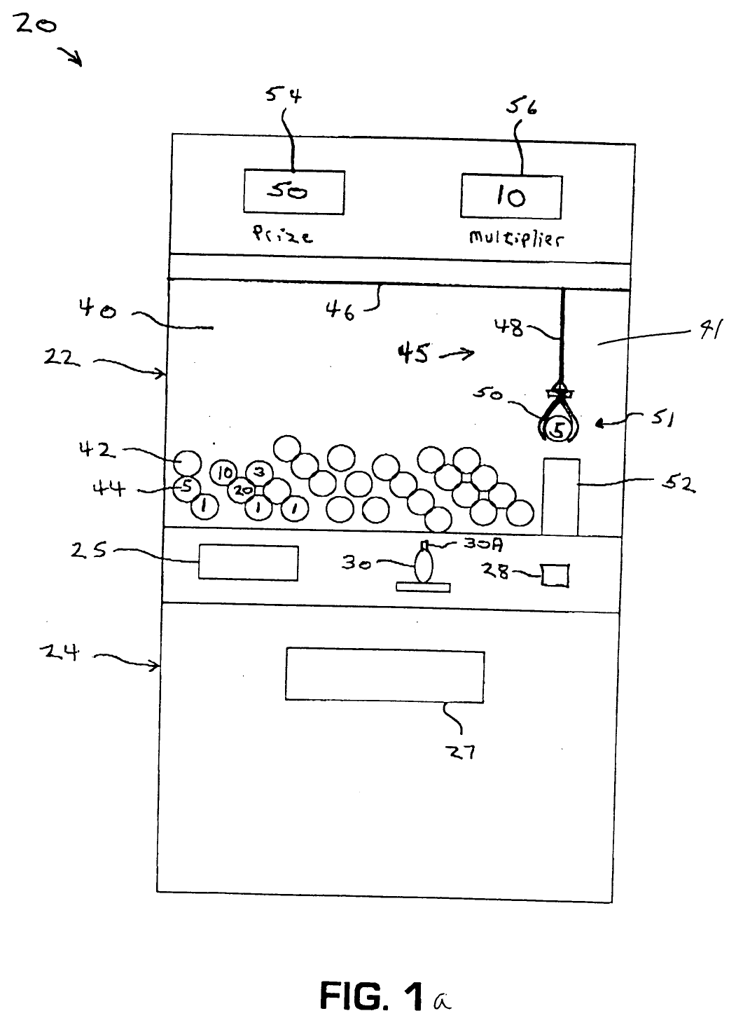

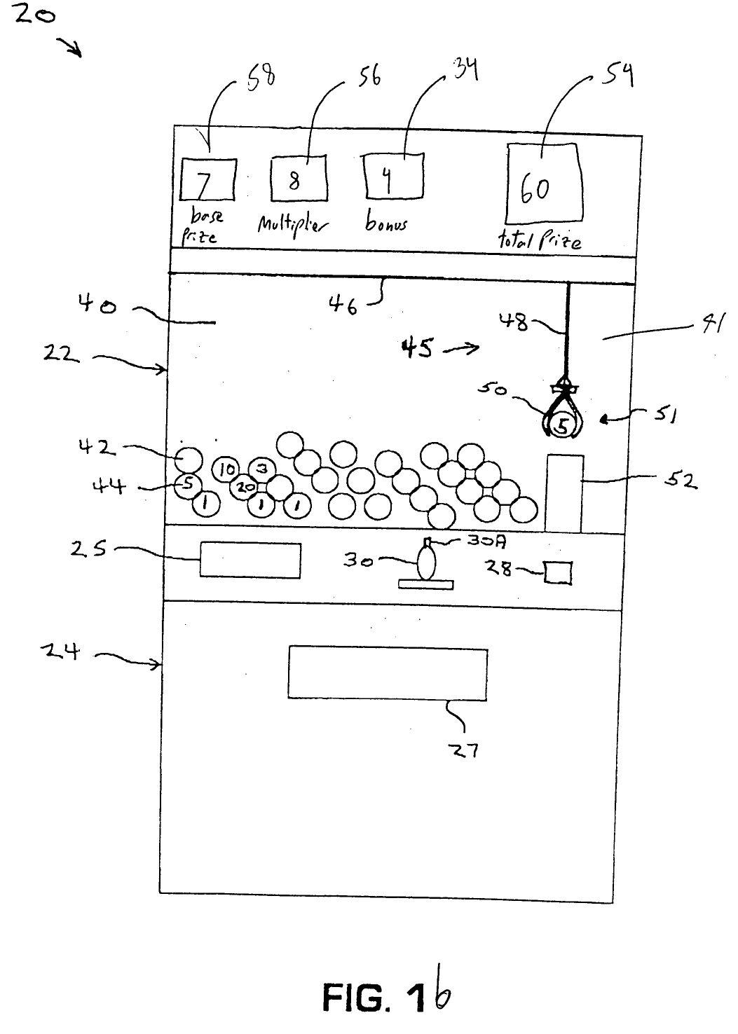

As seen in FIG. 1, the present invention comprises a gaming device, generally indicated by reference number 20. Gaming device 20 comprises a skill game device 22.

Skill Game Device

Skill game device 22 allows a player to play a game and to at least partially influence the outcome of a skill game. The outcome of the skill game may appear to be used to determine a game outcome. However, the game outcome is randomly determined and not influenced by the outcome of the skill game.

In the skill game, the player may use some form of skill, such as coordination, reaction time, judgment, or knowledge, to influence the skill game. Skill game device 22 may comprise an input device 30 and a display device 40. Input device 30 may be one or more of many different types of input devices that are well known in the art that allow a player to input information into skill game device 22 to interact with the device. For example, input device 30 may be a keyboard, a switch, a trackball, mouse, steering wheel, button, joystick, touch screen, microphone, etc. Display device 40 may be any of a large variety of devices that display information to the player, such as a video display or a mechanical display.

Skill game device 22 may provide a primary game of gaming device 20 or it may be combined with one or more other game devices. Skill game device 22 may be independently activated or it may be activated based on an outside event, such as a bonus activating event of a primary game. Once skill game device 22 is activated, a player may play the device using skill to influence the outcome of the skill game. As will be discussed in more detail below, gaming device 20 makes it appear as though the outcome of the skill game is used at least in part to determine a prize that is awarded to the player.

Game Apparatus

Gaming device 20 may also comprise a game apparatus 24. Game apparatus 24 may be any of a large number of devices that are adapted to allow a player to place a wager and play a game of chance. Game apparatus 24 may have a coin slot or card reader 25 for accepting wagers and a coin or voucher dispenser 27 for awarding prizes. A button 28 is provided for activating game apparatus 24 to begin a game.

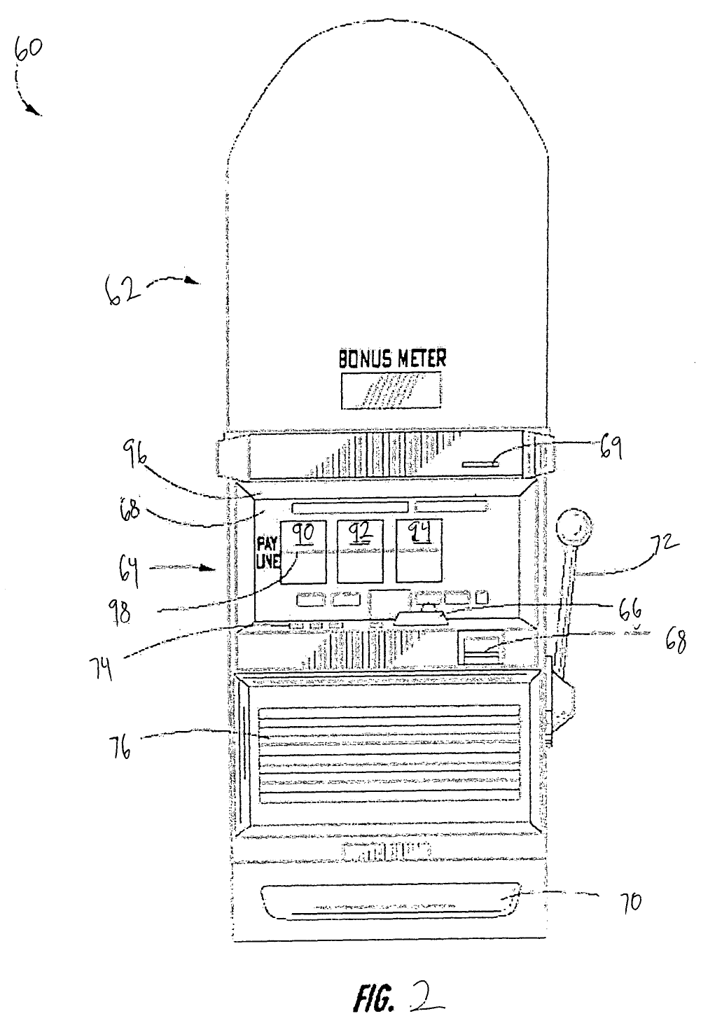

The methods, processes, and apparatus of the present invention can be used with many different types of gaming machines, including wagering devices such as slot machines, video poker machines, and the like. One example of a suitable gaming device is the slot machine illustrated in FIG. 2.

As seen in FIG. 2, the present invention comprises a gaming device, generally indicated by reference number 60. In at least one embodiment, gaming apparatus 60 comprises a prize display 62 and a gaming device 64. Gaming device 64 may be adapted to allow a player to place a wager and play a game.

Gaming device 64 may include a value acceptor for accepting value from a player, such as a coin slot 66, and/or a device 69 capable of reading and/or dispensing cashless devices. Gaming device 64 may also include a device 68 for accepting paper currency. In addition, a payout mechanism (not shown) and a coin receptacle 20 may be provided for awarding prizes or for dispensing value to players cashing out and retiring from a game. A printer (not shown) may also be provided for printing out cashless vouchers. A handle 72 and a button 74 may be provided for activating gaming device 64 to begin a game. A pay table 76 may further be provided to allow a player to see what symbol or combination of symbols provide a winning event. In at least one embodiment, gaming device 64 may be an S Plus model gaming device manufactured by International Game Technology in Reno, Nev.

Gaming device 64 may further include a gaming outcome display 78 that may be positioned so that a player (not shown) playing gaming device 64 can see the display 78. Game outcome display 78 may utilize physical game reels 90, 92, and 94. Game reels 90, 92, and 94 may be attached to a drive mechanism (not shown) of gaming device 64 to rotate the reels in a manner well known in the art. Each game reel 90, 92, and 94 may have a plurality of symbols (not shown) positioned on the circumference of each game reel 90, 92, and 94. Game reels 90, 92, and 94 may be positioned side-by-side with coincident axes of rotation and a portion of their individual circumferences facing outward from gaming device 64.

A panel 96 may cover game reels 90, 92, and 94 such that only a portion of their individual circumferences is shown to the player. At least one symbol from any of game reels 90, 92, and 94 may be used to display a game outcome. At least one pay line 98 may be provided for the player to use in determining a game outcome based on the symbol or a combination of symbols positioned thereon. In an alternative embodiment, gaming outcome display 78 utilizes a video display (not shown) displaying images of game reels and images of at least one pay line. A video display may also display game symbols in many other formats and arrangements, such as playing cards.

Gaming apparatus 60 may have a prize display 62 configured to display at least one game and prize to a player. Prize display 62 may be configured to display a bonus game and at least one bonus prize to the player. In other embodiments, prize display 62 may provide a primary game. Alternatively, prize display 62 may be a stand-alone device allowing a player to place a wager and play a game. Prize display 62 may be skill game 22.

In at least one embodiment, prize display 62 is attached to gaming device 64 and positioned on top of gaming device 64. In other embodiments (not shown), prize display 62 may be separate from gaming device 64 but in communication with gaming device 64. In this embodiment, prize display 62 may be in communication with a plurality of different gaming devices 64 via a computer network in a manner that is well know in the art. Prize display 62 may be positioned adjacent to or remote from gaming device 64. In other embodiments, prize display 62 is a stand-alone display not in communication with gaming device 64 and it may be capable of independently accepting wagers and awarding prizes to a player.

Game apparatus 24 may also be capable of producing a bonus-activating event that activates or enables skill game device 22. A bonus-activating event may be many different types of events. For example, a bonus-activating event may occur when a random number generator generates a number in a predetermined range of numbers. Furthermore, a bonus-activating event may occur when a player accumulates a number of symbols or prizes over a number of separate game plays. The bonus-activating event may also be an external event. For example, a bonus-activating event may occur when a group of players obtain a certain result. A bonus event may be indicated by the display of a special symbol or combination of symbols.

Processor

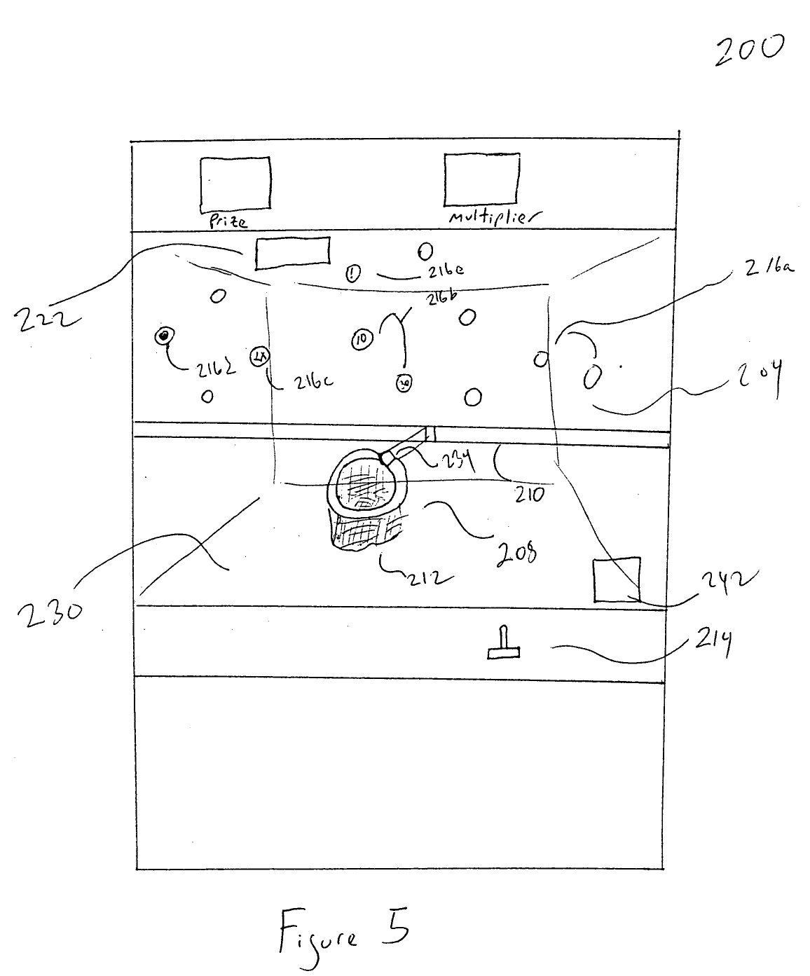

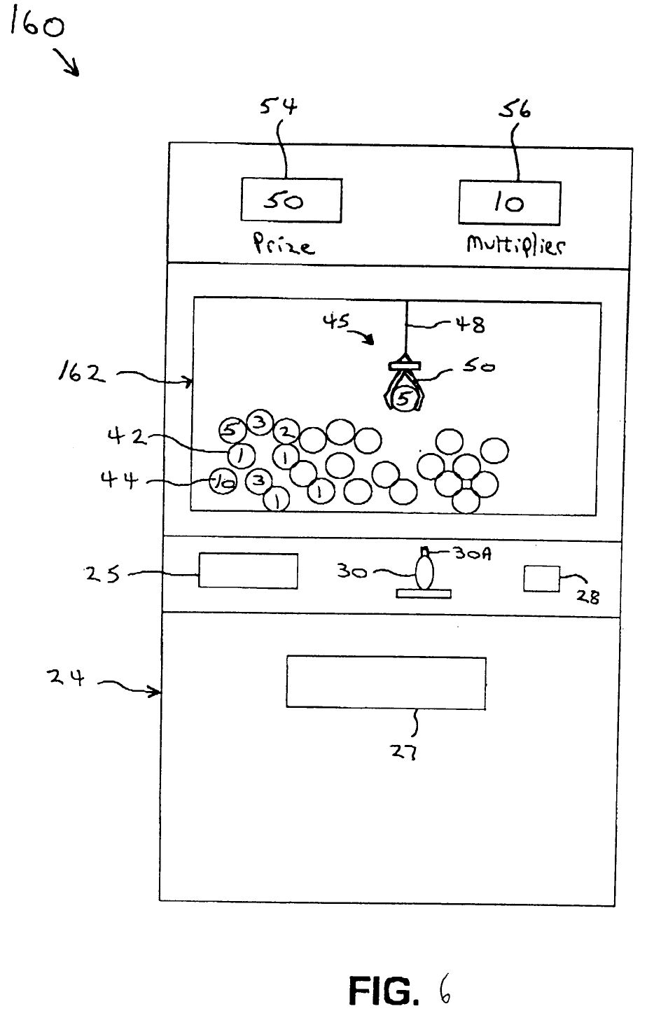

Gaming device 20 comprises a controller or processor 82 (see FIG. 6). Processor 82 may be any of a large variety of computer devices that are capable of performing computations and controlling external devices. Processor 82 may be a single device or it may comprise a number of devices that perform different functions or are in different locations in gaming device 20. Processor 82 may control both skill game device 22 and game apparatus 24 or it may control only one. In the embodiment disclosed in FIG. 5, processor 82 primarily controls skill game device 22 and game apparatus 85 controls game apparatus 24. In this embodiment, the two processors communicate over a communication network 87.

Processor 82 may comprise a random number generator and a multiplier generator. The random number generator produces a random or pseudo random number for each game. An outcome may be determined by comparing the random number to a table of outcomes stored in a memory and accessed by controller 82. In at least one embodiment, controller 82 generates a random number and then compares the random number to a pay table. A simple pay table may be represented as follows:

TABLE 1

| Random | Amount |
|---|---|
| Number | Paid |
| 0.00 to 0.50 | $1.00 |
| 0.51 to 0.75 | $5.00 |
| 0.76 to 0.95 | x 2 |
| 0.96 to 1.00 | $1,000.00 |

For example, if the random number generator produced a result of 0.65, the player may be awarded $5.00. If the random number generator produced a result of 0.80, the game outcome may be a quantity (determined by another part of the game) multiplied by two. A number of different tables of outcomes may be used and different tables may be used for different games. The tables can be designed so that different prizes have different probabilities of being awarded. Such design techniques are well known in gaming. Examples of such designs are described in U.S. Pat. No. 4,448,419, issued to Telnaes, and U.S. Pat. No. 5,456,465, issued to Durham. Controller 82 awards a prize that corresponds to the outcome of the random number generator. Game apparatus 20 may operate in many other ways and still achieve the objects of the present invention.

Once processor 82 has determined a prize, it may wait for skill game device 22 to produce a skill outcome. The skill outcome is at least partially influenced by the player. Multiplier generator 84 then determines a multiplier. The product of the outcome of the skill game and the multiplier is equivalent to the prize. For example, if processor 82 determined that the prize is $50 and the outcome of the skill game is $5, multiplier generator 84 would divide the prize by the outcome to obtain a multiplier of 10. If the player were more skilled and obtained a skill game outcome of $10, the multiplier would be 5. Similarly, a multiplier of 1 would be used if the result of the skill game was $50.

It may be desirable to select prize amounts and possible skill game outcomes so that any multiplier that is determined is an integer. For example, if a prize was $5, and a skill game outcome of 2 was achieved, the multiplier would be 2.5. If proper care is not selected in choosing potential values, fractional multipliers may result. Fractional multipliers may be undesirable because they may cause players to become suspicious that the skill game outcome is not really being used to determine their prize. Whole number multipliers may seem more plausible or natural to players, who may therefore be more likely to believe that their skill has influenced the prize.

Alternatively, if the quotient of the prize and the skill game outcome is not a whole number, the multiplier can be rounded up or down to the next integer. The remainder can be added to give the final prize. The remainder can be disguised as a form of a bonus. The remainder may be shown to the player, or may be hidden from the player.

An illustrative embodiment of this aspect of the present invention is shown in FIG. 1b. A base prize 58 (a value of 7) is illustrated, which may correspond to the outcome of the skill game. For example, in the illustrated embodiment, the player has achieved a skill game outcome of 7. A total prize 54 (a value of 60) is also shown. Total prize 54 may correspond to prize 54 of FIG. 1a. As has been previously described, a multiplier is calculated by dividing the total prize by the skill game outcome.

In the example of FIG. 1b, 7 goes into 60 eight times with a remainder of 4. In this embodiment, 8 is used as multiplier 56, which may be displayed to the player. The remainder 34 (a value of 4) may be shown to the player. Remainder 34 may be called other things, such as a bonus, to make it seem less artificial to players.

Display Devices

Gaming device 20 may comprise one or more display devices in communication with controller 82. As seen in FIGS. 1 and 6, at least one embodiment of the invention comprises a prize display 54 for displaying the value of the prize and multiplier display 56 for displaying the multiplier. Once controller 82 determines the prize and multiplier, it causes displays 54 and 56 to display the appropriate values.

Crane Display

The embodiment shown in FIG. 1a utilizes a crane-type game of a type that is well known in arcade type games. In this embodiment, input device 30 is a joystick that allows the player to manipulate crane or claw 45. Joystick 30 may have one or more buttons 30A to further control the operation of claw 45. In this embodiment, display device 40 may comprise a container 41 that is adapted to hold a plurality of display balls 42. Container 41 may be at least partially transparent allowing players to view display balls 42 inside of the container. Container 41 may be made of acrylic or other materials, including, without limitation, plastic, glass, or wire mesh. Display balls 42 may be any type of ball, such as keno balls, ping-pong balls, rubber balls, or the like. One or more display balls 42 may have indicia 44, such as numbers, letters, symbols, pictures, words, or colors, presented on the surface of the balls so as to be visible to the player. The indicia may be used to indicate the outcome of the skill game. A system described in U.S. Pat. No. 6,338,678 B1 entitled “Ball Selector and Display Device for Use with Gaming Devices,” which is incorporated herein by reference, may be used in conjunction with the present invention.

Skill game device 22 may also comprise a crane 45, crane rail 46, crane arm 48, jaws 50, and sensor 52. Crane rails 46, crane arm 48, and jaws 50 are well known in the art. Crane display may be designed in various ways and still be within the scope of the present invention. For example, instead of jaws 50, a scooper may be used. Crane 45 may also be designed to be positioned or moved differently. For example, crane 45 may be configured to rotate within container 40. Crane may also be configured to be attached to the side of container 40.

Joystick 30 is adapted to control crane 45. A game player moving joystick 30 may cause the crane arm 48 to move in an x-y axis (such as up, down, and from side to side), or other type of movement, over display balls 42. Depressing joystick button 30A may cause arm 48 to move downwardly with jaws 50 opened. After jaws 50 have moved down into contact with display balls 42, releasing button 30A may cause jaws 50 to clamp shut upon one of the display balls 42. After one of the display balls is selected by the game player, the selected display ball is moved to a display position 51 above sensor 52. At display position 51, the indicia on the display ball is viewable by the player. In this manner, the game player is able to use his or her skill at manipulating the crane to select display ball 42 that the player thinks would grant him the best outcome.

Many variations on the skill game can be made without departing from the scope of the present invention. For example, the player could be given a limited or unlimited number of tries to play the skill game, win the skill game, or achieve a particular result in the skill game. For example, in the crane embodiment, the player could be allowed an unlimited number of tries to select a ball. Alternatively, the player might be given a fixed number of tries to get a ball. The number of tries could be fixed, or could be randomly determined by the gaming apparatus.

If the player is allowed multiple opportunities to play the skill game, the skill game may be set to end at the first winning attempt by the player. Alternatively, the player could be allowed to use all their attempts to play the skill game, with the gaming apparatus using the highest/best result achieved by the player. If the player is allowed multiple attempts, the skill game outcome could be the sum of the results of each attempt.

Sensor 52 is adapted to determine the identity of the display ball retrieved by crane 45. Sensor 52 may be an optical reader, a magnetic reader, an electromagnetic reader, or other sensors that are well known in the art. For example, the display balls could be magnetically encoded and the sensor 52 could be a magnetic reader. Sensor 52 may provide an electrical signal that is communicated to processor 82 (see FIG. 5). After the display ball has been displayed for a period of time, the controller causes crane 45 to return the display ball to a random position within container 40. Crane 45 then returns to a starting position for the next game. Container 40 may also include an agitator (not shown) to mix the display balls. The agitator may be a mechanical arm or a stream of air that mixes the display balls.

Processor 82 may receive the electrical signal that communicates the identity of the display ball retrieved by crane 45. Processor 82 may have previously generated a prize using a random number generator 83. In at least one embodiment, the prize is not revealed to the player at this point. Processor 82 calculates a multiplier using a multiplier generator 84. The multiplier is equal to the quotient of the previously generated prize divided by the indicia value. For example, in FIG. 1a, the indicia value is 5. Assuming that the random number generator had selected a prize equal to 50, the processor would calculate a multiplier of 10 (by dividing 50 by 5). The multiplier is then displayed on the skill game device 22 so that when the multiplier is multiplied by the indicia selected by the player, the product is the prize determined by processor 82, which is also displayed on the skill game device 22. Thus, a player perceives that his or her skill in selecting display ball 42 influenced the value of the prize he or she received. The prize value can be awarded in coins, dollars, or credits. If the actual prize is money, the amount of the prize may be added to the player's credit meter or the prize may be dispensed from coin dispenser 27.

Basketball Display

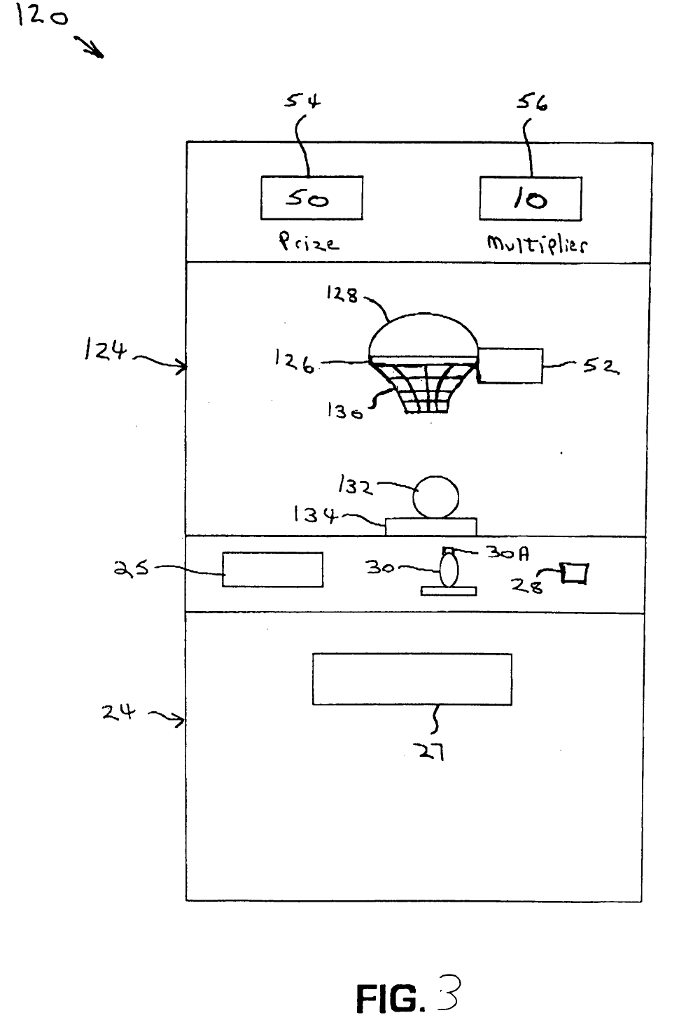

Referring to FIG. 3, gaming device 120 comprises a basketball skill game device 124 attached above game apparatus 24. Basketball display device comprises a hoop 126, backboard 128, net 130, basketball 132, and ball thrower or launcher 134. Moving joystick 30 causes the ball thrower 134 to change the direction of travel of basketball 132. Ball thrower 134 can throw the ball to the left, right, straight, close or far depending upon the position of joystick 30. Ball thrower 134 may be a spring loaded lever. Depressing joystick button 30A causes ball thrower 134 to shoot basketball 132 toward net 130. The ball either goes through hoop 126 to score a basket or misses resulting in no score. The ball may be returned to launcher 134 through a hidden track or a tube. Depressing button 28 starts the game after a wager has been placed in coin acceptor 25.

Sensor 52 detects the number of times that the game player makes a basket. For example, in a game, the game player may be given the opportunity to shoot the basketball 10 times. If the player makes 5 baskets, they will have achieved a score of 5. In this manner, the game player is able to use his or her skill at manipulating the ball thrower to influence or determine the outcome of the game. Sensor 52 is adapted to count the number of times the ball 132 passes through hoop 126. Sensor 52 can be a device such as a proximity sensor or it may be a reed switch. Sensor 52 provides an electrical signal to processor 82 that indicates the number of times a basket has been made.

Processor 82 receives the electrical signal from sensor 52. Processor 82 has or will generate a prize using a random number generator 83. In the preferred embodiment, this prize is not revealed to the player at this point. Processor 82 calculates a multiplier using a multiplier generator 84. The multiplier is equal to the previously generated prize divided by the number of baskets made. For example, in FIG. 3, the number of baskets made is 5. This is outcome of the skill game device 124. Assuming that the random number generator had selected a prize equal to 50, processor 82 would calculate a multiplier of 10 (by dividing 50 by 5). The multiplier is then displayed on the multiplier meter 56 so that when the multiplier is multiplied by the number of baskets the player made, the product is the prize the player won, which is displayed on the prize meter 54. Thus, a player perceives that his skill in making the baskets caused him to win or increase his prize. The prize value can be awarded in coins, dollars, or credits. If the actual prize is money, the amount of the prize may be added to the player's credit meter or the prize may be dispensed from coin dispenser 27.

Baseball Display

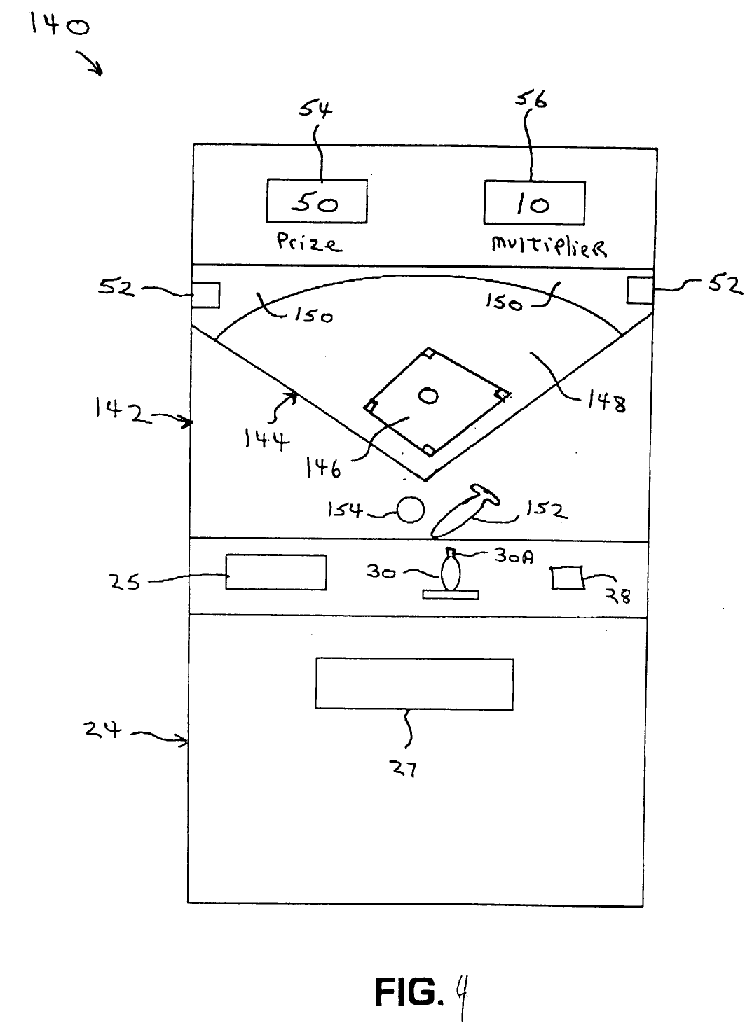

Referring to FIG. 4, gaming device 140 has a baseball skill game device 142 attached above game apparatus 24. Baseball skill game device 142 comprises a playing field 144, infield 146, outfield 148, home run area 150, bat 152, and baseball 154. A game player moving joystick 30 causes bat 152 to change the direction in which baseball 154 is hit. Bat 152 can hit the ball to the left, right, straight, close, or far depending upon the position of joystick 30. Depressing joystick button 30A causes bat 152 to hit baseball 154 toward infield 146 and outfield 148. The ball either goes into infield 146, outfield 148, or into home run area 150. Depressing button 28 may start the game after a wager has been placed in coin acceptor 25.

When baseball 154 lands in the outfield or infield, the skill game may be configured such that no points are scored. When baseball 154 lands in home run area 150, it may be detected by sensor 52. Sensor 52 may detect scoring events, such as the number of times that the game player makes a home run or the number of times the game player hits the ball. For example, in a game the game player may be given the opportunity to hit the baseball 10 times. One point may be awarded for each home run the player hits. If the player makes 5 home runs, the player will have achieved a score of 5 points. In this manner, the game player is able to use his or her skill to manipulate the bat to influence or determine the outcome of the skill game. Sensor 52 may be adapted to count the number of times a home run is made. Sensor 52 may be a variety of well known sensors, such as a proximity sensor. Sensor 52 may provide an electrical signal to processor 82 that indicates the number of times a home run has been made. Processor 82 may receive the electrical signal from sensor 52.

Processor 82 has or will generate a prize using random number generator 83. In at least one embodiment, this prize is not revealed to the player at this point. Processor 82 calculates a multiplier using multiplier generator 84. The multiplier is equal to the previously generated prize divided by the number of home runs made. The multiplier is then displayed on the multiplier meter 56 so that when the multiplier is multiplied by the number of home runs the player made, the product is the prize the player won, which is displayed on the prize meter 54. Thus, a player perceives that his skill in hitting the home runs caused him to win or increase his prize.

The prize value can be awarded in coins, dollars, credits, goods, or services. If the actual prize is money, the amount of the prize may be added to the player's credit meter or the prize may be dispensed from coin dispenser 27. Sensor 52 can also be programmed according to operator's desires. For example, it can be programmed to detect other types of baseball hits besides home run or it may be programmed to rate player's skill besides basing the score on the number of home runs.

Other sensors devices, such as speakers, lights, and vibration devices (not shown) may be incorporated in skill game device 142 to enhance the overall stimulation of the game. For example, when a player hits a home run, the sound of a cheering crowd may be played over the speakers. These sensory devices may be controlled by processor 82 in a way that is well known in the art.

It is understood that the skill game device of the present invention may be configured with varying themes and still fall within the scope of the invention. For example, instead of basketball or baseball, display device may be configured with hockey, darts, soccer, golf, hunting, volleyball, warfare simulators, pinball, word games, guns, and the like.

The input device for the skill game may be customized according to the theme. For example, for hockey and golf, the input device may be adapted to allow user to manipulate a hockey stick or a golf club, respectively.

The game outcome may be based on the conventional method of scoring a particular game. For example, for hunting, the outcome may be based on the number of times a target is hit. For darts, the outcome may be based on the pre-determined value of a target area on which the dart has landed. Of course, the convention scoring method can be modified or changed as desired by the game operator or designer without departing from the scope of the present invention. The sensor may be positioned according to the manner of scoring the game outcome.

Hoop Display

Another embodiment of the present invention is illustrated in FIG. 5. FIG. 5 shows a skill game device 200 that has a moveable hoop 208. Hoop 208 may be fitted with net 212. Hoop 208 may be moved within display area 204, such as along rail 210. Rail 210 may allow hoop 208 to move from side to side within display area 204. Of course, hoop 208 may be configured to move in other manners, such as in a plane within display area 204 and/or vertically within display area 204.

Hoop 208 may be controllable by a player through a player input device 214, such as a joystick. Of course, other player input devices could be used, such as buttons, keyboards, a mouse, a trackball, touch screens, and the like.

A player may control hoop 208 through input device 214 in order try to cause one or more balls 216 pass through hoop 208 (also referred to as catching the ball). Balls 216 may be of various types, including balls bearing no indicia 216a, balls displaying or representing prize values 216b, multiplier amounts 216c, a good or a service 216d, and special prizes 216e, such as progressive prizes or jackpot prizes.

Balls 216 may be released into display area 204 from ball dispenser 222. Ball dispenser 222 may be configured so that balls 216 fall downward from above hoop 208. A player may have the opportunity cause balls 216 to pass through hoop 208. Ball dispenser 222 may also ricochet balls 216 off the sides of display area 204 in order to make the display more interesting and make the skill game more challenging.

Balls 216 may be collected at the bottom of display area 204 and returned to ball dispenser 222. The bottom of display area 204 may be sloped and funnel into an opening to feed balls 216 into a ball return mechanism (not shown). In an alternate configuration, the bottom of display area 204 could be covered by a grate (not shown) through which balls 216 may pass and enter the ball return mechanism.

Various ball return mechanisms may be used without departing from the scope of the present invention. For example, a conveyer belt type system could be employed. The conveyer belt might have one or more tracks, scoops, or other means for carrying balls 216 from the bottom of display area 204 to ball dispenser 222.

Alternatively, a waterwheel type mechanism could be used. The waterwheel may have a series of groves or compartments that may scoop up balls 216 from the lower part of display area 204, carry them as the wheel rotates balls 216 to an upper portion of display area 204 for delivery to ball dispenser 222. The waterwheel may be configured to feed balls 216 directly into ball dispenser 222. Alternatively, the waterwheel mechanism may feed balls 216 into a delivery system that will deliver balls 216 to ball dispenser 222. For example, balls 216 may be dropped onto a slide or funnel that gravity feeds balls 216 into ball dispenser 222.

Another ball return mechanism may be an auger. Balls 216 may be directed to the auger, which may have channeled spirals to better hold balls 216. As the auger rotates, balls 216 will be carried upwards towards the top of display area 204. At the top of display area 204, balls 216 may be directed into a slide, funnel, or similar mechanism for delivery to ball dispenser 222. Of course, the present invention is not limited to any particular ball dispenser or ball return mechanism. Any suitable known, or later developed, dispenser and/or ball returned mechanism may be used without departing from the scope of the present invention.

Many different types of game play can be used with the hoop embodiment of the present invention. In one embodiment, balls 216 all have the same value. The object of the game may be for the player to have as many balls 216 pass through hoop 208 as the player is able. The player may be given only a limited time to play the game. In this embodiment, hoop 208 may include a sensor 234 for detecting when a ball 216 passes through hoop 208.

Any suitable sensor can be used. In one embodiment, an optical sensor is used. When a ball 216 passes through hoop 208, it may disrupt an optical signal, thereby sensing that the player has successfully had a ball 216 pass through hoop 208.

An inductive loop may also be used. Hoop 208 may include an inductive loop. Balls 216 may contain a magnetic or metallic substance. When a ball 216 passes through hoop 216, the metallic or magnetic substance in the ball may cause the inductance of the inductive loop to change, thereby sensing that they player has successfully caused a ball 216 to pass through hoop 208.

If hoop 208 is fitted with net 212, another sensor mechanism may be used. After the game is over, hoop 208 may be moved over a sensor area 242. In one embodiment, hoop 208 may be rotated upside down compared to its game position. In the manner, net 212 may be emptied. Any display balls 216 may pass proximate a sensor for detection. In this case, the sensor may be a mechanical sensor, such as a spring loaded trigger, that may sense contact with balls 216.

In other game play embodiments, it may be beneficial to know the exact identity of each ball 216 the player successfully passes through hoop 208. Various systems can be used to identify each ball 216. For example, the inductance altering properties of balls 216 may vary. A controller (not shown) may correlate a particular induction change to a particular ball 216 or balls 216. Accordingly, when the player successfully has a ball 216 pass through hoop 208, the controller will know not only that the player has successfully caught a ball 216, but will also know what that ball 216 represents. This embodiment may also be used in the embodiment where hoop 208 is equipped with a net 212. The inductance loop may be included in sensor area 242.

Other sensing mechanisms may be used, including optical sensors such as bar code scanners and the like. Other systems may employ unique semiconductors, or other items, located inside balls 216. Suitable systems include those described in U.S. Pat. No. 5,799,940 to Tripp, which is hereby incorporated by reference. Such systems may be configured for detecting balls as they pass through hoop 208. Unique transmitters, such as RFID (radio frequency identification) tags may also be placed inside balls 216. Other systems may be better suited to detect the identity of balls 216 when passed through sensor area 242.

In embodiments where balls 216 have different values, players may use their skill to not only catch balls, but to catch balls with higher or more valuable values. It may be desirable to include a larger number of balls 216 having no value, or low values, compared to higher value balls. In addition, the movement characteristics of balls 216 may be altered so that low or zero value balls 216 are easier to catch than high value balls 216. For example, high value balls 216 may be made heavier and less flexible than low value balls 216. Therefore, the high value balls 216 may have different movement properties, such as ricocheting less, than their low value counterparts, making them harder for players to catch. Although the skill game outcome does not affect the prize awarded the player, it still may be beneficial to maximize players' chance to use their skill. The skill game may thereby provide additional enjoyment, excitement, and satisfaction for the player, apart from winning prizes.

Video Display

Referring to FIG. 6, a skill game device 160 is shown. Skill game device 160 comprises a video display 162 and a game apparatus 24. Skill game device 160 is similar to skill game device 22 except that display device 40 is replaced by a video display 162. Video display 162 presents an image of display balls 42 and crane 45 that is shown to the player. Video display 162 may be any of a large number of display devices that are well known in the art. For example, video display 162 may be a cathode ray tube of a type that is used with many personal computers, plasma displays, LCD displays, or any other suitable display device.

Video display 162 may be in communication with processor 82. Alternatively, a video processor card (not show) may be interposed between video display 162 and processor 82. Processor 82 transmits messages to video display 162 to request the display to produce different displays. For example, controller 82 may send a signal to video display 162 to move crane 45 in response to the movements of joystick 30. The operation of skill game device 160 is the essentially the same as for gaming device 10. Skill game device 160 does not require a sensor 52 because processor 82 already contains the ball information. Physical meters 54 and 56 could be eliminated by integrating them into video display 162. Of course, it physical meters 54 and 56 may still be used and may present a more varied display to game players, which may increase the visual appeal of the game.

Video display 162 may comprise a video controller (not shown) that drives the display device to present various displays. Many different well-known video controllers may be used. Software and data used to produce different presentations may be stored on the video controller in non-volatile memory, such as, but not limited to, compact disks, magnetic disk drives, or erasable programmable read only memory (EPROM). Video display 162 may display other information in graphic and text form, such as instructions on how to use the gaming device. Audio speakers may be provided for presenting audio content, such as sound effects or music when a prize is won.

This embodiment has the advantage of reducing maintenance because the moving parts of a mechanical display are eliminated. This embodiment also provides greater flexibility because many different kinds of presentations may be displayed on the video display 162. A player may be allowed to select between various games. This allows players who believe they are good at playing a certain type of game to select that game.

Game System

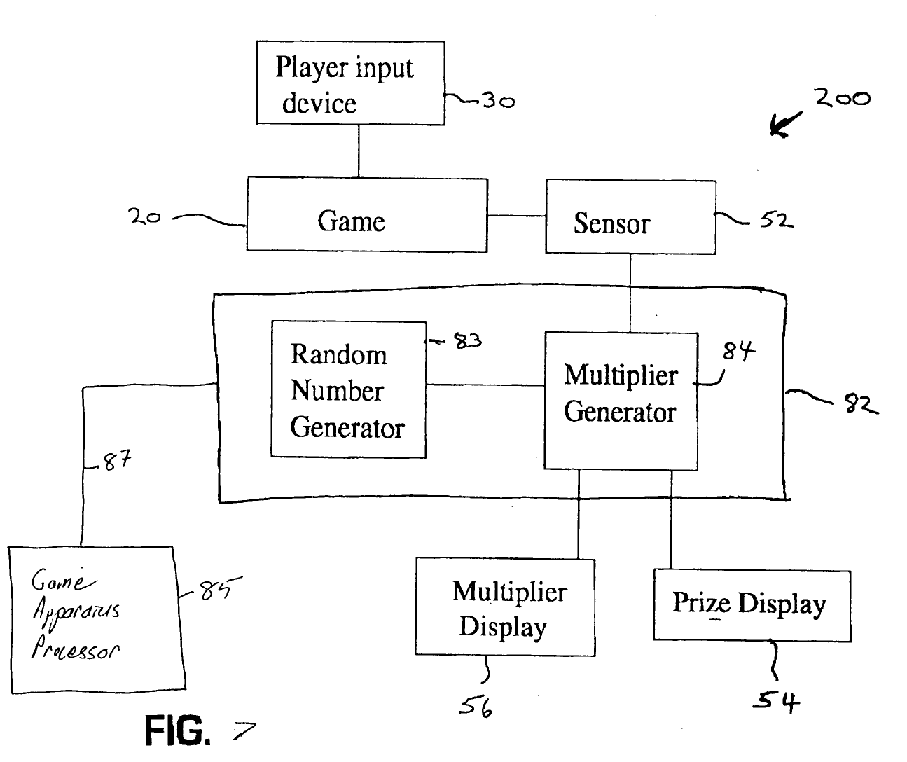

Turning to FIG. 7, a schematic diagram of the game system 200 of the present invention is shown. Game system 200 uses game 20 that has player input device 30 and sensor 52 connected. Sensor 52 transmits a signal to processor 82 that is indicative of the outcome of the skill game. Processor 82 comprises a random number generator 83 and multiplier generator 84. Processor 82 drives prize display 54 and multiplier display 56. Controller 82 may be a single processor or processor board.

Flow Chart

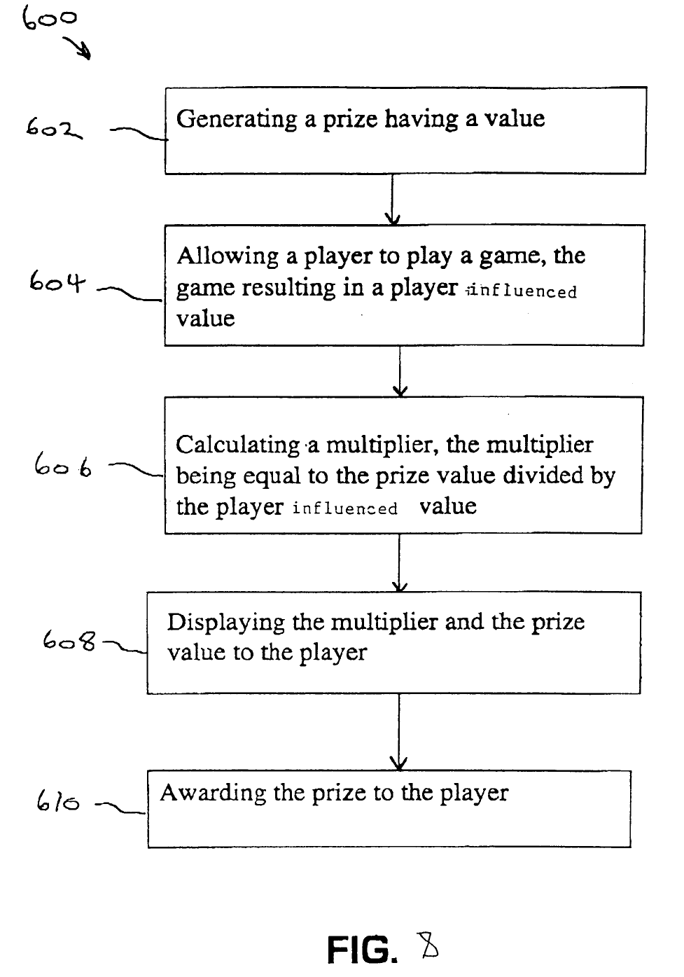

Turning now to FIG. 8, a flowchart 600 of the operation of gaming device 20 is shown. The present invention comprises a method that may be applied to many different games. The method includes generating a prize having a value at step 602. The prize value is preferably randomly generated and is not revealed to the player until after the player has finished playing the skill game. However, it is recognized that this step may occur later in the method of operation. Next, at step 604, the player is allowed to play skill game device 22. The player is allowed to use his or her skill to influence the outcome of the game, such as picking up a ball, shooting a basket, or hitting a baseball. The outcome of the game results in a skill game outcome. At step 606, a multiplier is calculated. The multiplier may be equal to the quotient of the prize divided by the skill game outcome. Next, at step 608, the prize value and the multiplier are displayed to the player on meters 54 and 56. At step 610 the prize is awarded to the player. The prize may be awarded in the form of credits that are added to a virtual bank. The method of flowchart 600 provides game players with the illusion that, through their performance, the player can influence the outcome of the game while in reality the prize value to be awarded has already been determined.

Bonus Game

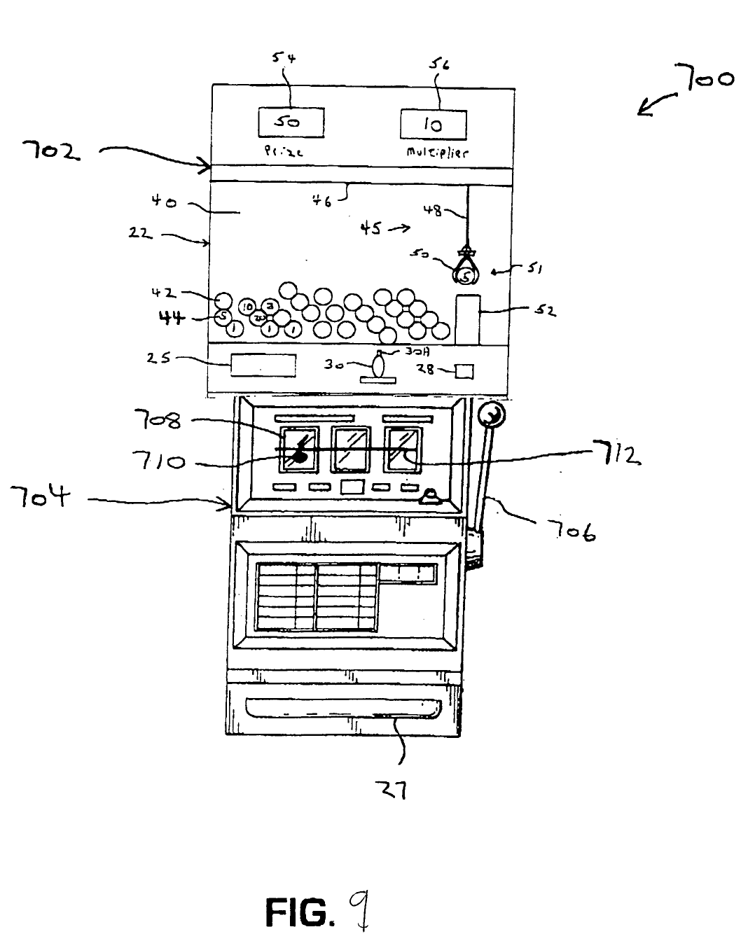

As seen in FIG. 9, the present invention can also be used as a bonus game. Bonus gaming device 700 comprises a bonus game 702 mounted on top of a primary game 704. Primary game 704 may be any of a large number of devices that are adapted to allow players to play a game, such as a slot machine. Bonus game 702 is similar in structure and operation to game apparatus 24 of FIG. 1a.

Primary game 704 has a lever 706 that a player may use to start the game after a wager has been placed. Game 704 is shown in FIG. 8 as a rotating reel type slot machine. Rotating reels 708 may have a bonus symbol 710. When bonus symbol 710 lines up on pay line 712, a bonus-activating event may occur and the bonus game 702 may be started. Controller 82 (see FIG. 5) may be configured to detect when a bonus-activating event occurs in primary game 704. This detection may be accomplished by primary game 704 transmitting a signal to controller 82 indicating that a bonus event has occurred. In another embodiment, one or more sensors may be provided for determining if a bonus-activating event has occurred. For example, sensors may sense the positions of the reels on primary game 704. Sensors may also be provided external to primary game 704 to detect external bonus-activating events.

When controller 82 (FIG. 7) detects a bonus-activating event, it begins a bonus sequence by activating bonus game 702. Bonus game 702 is played in the same manner as skill game device 22 of FIG. 1a. The player uses his skill to determine a game outcome, which is then multiplied by a multiplier to determine the prize to be awarded.

Bonus Game Flow Chart

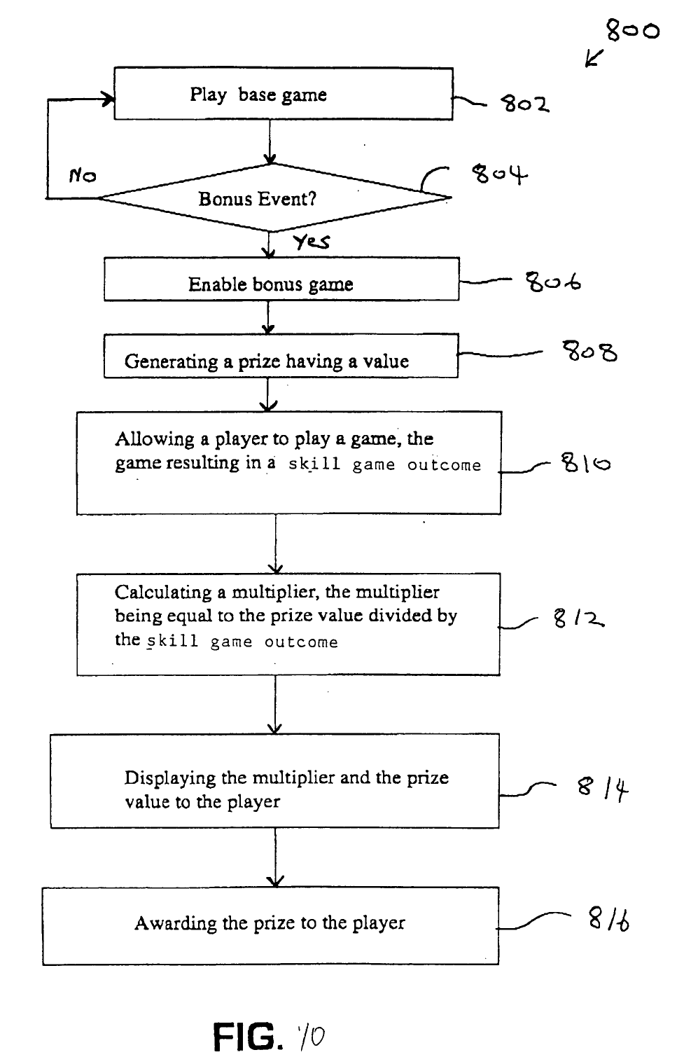

Turning now to FIG. 10, a flowchart 800 of the operation of the bonus game apparatus 700 is shown. The present invention comprises a method that may be applied to many different games. The method includes a game player playing primary game 704 at step 802. At step 804, it is determined whether a bonus qualifying event has been generated by primary game 704. If a bonus-qualifying event has not occurred, the game returns to step 802 where the player is allowed to play the primary game 704 again. If a bonus-qualifying event has occurred, the game proceeds to step 806 where bonus game 702 is enabled. Next, bonus game 702 generates a prize having a value at step 808. The prize value may be randomly generated and is not revealed to the player. Next, at step 810, the player is allowed to play bonus game 702. The player is allowed to influence the outcome of the game, such as picking up a ball, shooting a basket or hitting a baseball. The outcome of the game results in a player-determined value. At step 812, a multiplier is calculated. The multiplier is equal to the prize value divided by the outcome of the skill game. Next, at step 814, the prize value and the multiplier are displayed to the player on meters 54 and 56.

As was discussed in conjunction with FIG. 1b, in certain embodiments the multiplier, which is the quotient of the prize and the skill game outcome, may not be an integer. If the multiplier is not an integer, the multiplier may be rounded down to the nearest integer and the remainder added to the product of the skill game outcome and the multiplier to give the prize. In at least one embodiment, the remainder may be displayed to the player.

At step 816 the prize is awarded to the player. The prize is awarded may be in the form of credits that are added to a virtual bank. The method of flowchart 800 provides game players with a bonus game that provides the illusion that, through their performance they are influencing the outcome of the game, while in reality, the prize to be awarded has already been determined.

### CONCLUSION

It can now be seen that the present invention solves many of the problems associated with the prior art. The present invention provides a gaming device that utilizes a skill game that may be used with a primary game or a bonus game. The present invention provides a gaming device that allows a game player to utilize his skill to influence a skill game outcome, while at the same time providing for a randomly generated prize. The present invention provides a gaming device that provides the illusion to a player that they are influencing a prize to be awarded. The present invention provides a display device that may require no human operators, and may require little maintenance.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A gaming device, comprising:
(A) a skill game device, the skill game device being configured to allow a player to play a game and to use skill to influence an outcome of the skill game, the skill game device comprising:
(a) an input device, the input device being configured to allow a player to input information into the skill game device to influence the outcome of the skill game;
(b) a skill game display device, the skill game display device being configured to display the outcome of the skill game;
(B) a processor in communication with the skill game device, the processor being configured to randomly determine a prize and to determine a multiplier, the product of the outcome of the skill game and the multiplier being equivalent to the prize;
(C) a prize display in communication with the processor, the prize display being configured to display the prize; and
(D) a multiplier display in communication with the processor, the multiplier display being configured to display the multiplier.

2. The gaming device of claim 1, further comprising a game apparatus, the game apparatus being configured to allow a player to place a wager and play a game of chance having an outcome.

3. The gaming device of claim 2, wherein the outcome of the game of chance is independent of the outcome of the skill game.

4. The gaming device of claim 2, wherein outcome of the game of change may comprise a bonus event, wherein the skill game device is enabled when a bonus event occurs.

5. The gaming device of claim 1, wherein the skill game display device comprises a container, and at least one ball is movably positioned inside the container.

6. The gaming device of claim 5, wherein the skill game display device comprises an agitator, the agitator being adapted to mix the balls inside the container, at least a portion of the balls having at least one indicia appearing on their exterior surface.

7. The gaming device of claim 5, wherein the skill game display device further comprises a hoop and a sensor in connection with the hoop, the sensor being adapted to detect a number of times the ball passes through the hoop.

8. The gaming device of claim 5, wherein the skill game display device further comprises a playing field and a sensor, the playing field having at least one target area, the sensor being adapted to detect number of times the ball lands in the target area.

9. The gaming device of claim 5, wherein the input device comprises a joystick, the joystick being in communication with a crane displayed within the skill game device, the crane having a jaw, the jaw being configured to grab a ball, the joystick being configured to move the crane towards a ball, the joystick also being configured to allow the jaw to grab a ball.

10. The gaming device of claim 5, wherein the input device comprises a launcher, the launcher being adapted to place the ball in projectile motion when the launcher is activated.

11. The gaming device of claim 10, wherein the input device further comprises a joystick, the joystick being in communication with the launcher, the launcher being positionable in a plurality of positions, the joystick being configured to control the position of the launcher.

12. The gaming device of claim 1, wherein the skill game display device comprises a video display, the video display being configured to show at least one indicia.

13. A gaming device comprising:
(A) a random number generator;
(B) a skill game device configured to allow a game player to play a game, the skill game having a skill game outcome, the skill game outcome being shown to the game player, wherein the skill game outcome may be influenced by the player;
(C) a processor in communication with the random number generator, the processor configured to randomly determine a prize, the processor further adapted to calculate a multiplier, the multiplier being the quotient of the prize divided by the skill game outcome; and
(D) a display in communication with the processor and the skill game device, the display being adapted to show the prize and the multiplier.

14. The gaming device according to claim 13, wherein the skill game device comprises a target game, the skill game outcome being at least partially based on the number of times the game player hits the target.

15. The gaming device according to claim 14, the target having a plurality of value areas having a plurality of values, wherein the skill game outcome is based on value of the area of the target the player hits.

16. The gaming device according to claim 13, wherein the skill game device comprises a basketball game, the skill game outcome being at least partially determined by the number of times the game player makes a basket.

17. The gaming device according to claim 13, wherein the skill game device comprises a baseball game, the baseball game comprises a home run area, the skill game outcome being at least partially determined by the number of times the game player hits a home run.

18. The gaming device according to claim 13, wherein the skill game device comprises a crane game, the crane game comprising a crane an at least one object that may be picked up by the crane, the skill game outcome being at least partially determined by the an indicia shown on an object that is picked up by the crane.

19. The gaming device according to claim 13, wherein the skill game device comprises a video display.

20. The gaming device according to claim 19, wherein the multiplier and the prize are shown on the video display.

21. The gaming device according to claim 13, further comprising a sensor in communication with the processor, the sensor being adapted to sense the skill game outcome.

22. The gaming device according to claim 21, wherein the sensor comprises an optical sensor.

23. The gaming device of claim 21, wherein the sensor comprises an inductance sensor.

24. The gaming device of claim 21, wherein the sensor comprises a frequency sensor.

25. The gaming device of claim 24 wherein the frequency sensor comprises a radio frequency identification tag sensor.

26. The gaming device according to claim 13, further comprising an input device in communication with the skill game device, the input device being adapted to allow the game player to influence the skill game outcome.

27. The gaming device according to claim 13, wherein the game player is presented with the illusion that that game player is influencing the selection of the prize.

28. The gaming device of claim 13 further comprising:
(A) at least one ball within the skill game device;
(B) a hoop moveably positioned within the skill game device, the hoop configured to allow a ball to pass through the hoop; and
(C) a player input device in communication with the hoop, the player input device configured to allow a player to selectively position the hoop.

29. The gaming device of claim 28 wherein the hoop further comprises a net.

30. The gaming device of claim 28 further comprising a ball dispenser located within the skill game device, the ball dispenser configured to project balls above the hoop.

31. The gaming device of claim 30, further comprising a ball return mechanism adapted to return balls dispensed from the ball dispenser back to the ball dispenser.

32. The gaming device of claim 28 further comprising a plurality of balls, wherein at least a portion of the balls may influence the skill game outcome, wherein at least a portion of the balls comprise identification means for identifying the ball.

33. The gaming device of claim 32, further comprising a sensor area comprising a sensor, wherein the identity of balls comprising identification means may be ascertained.

34. A method of playing a game comprising, not necessarily in the order shown:
(A) determining a prize;
(B) allowing a player to use skill to determine a skill game outcome;
(C) dividing the prize by the skill game outcome to determine a multiplier;
(D) displaying the multiplier to the player; and
(E) awarding the prize to the player, wherein it appears that the prize is the product of the skill game outcome and the multiplier.

35. The method of claim 34, wherein the prize is randomly determined.

36. The method according to claim 34, wherein the prize is hidden from the player until after the player uses the player's skill to obtain a skill game outcome.

37. The method according to claim 34, further comprising:
(A) providing a display device, the display device containing at least one display ball; and
(B) providing an input device, the input device being configured to allow a player to select at least one display ball.

38. The method according to claim 37, wherein the display ball comprises an indicia affixed on the display ball, the method further comprising allowing the player to manipulate the input device to select the display ball.

39. The method of claim 34, further comprising providing a game apparatus, the game apparatus being configured to allow a player to place a wager and play a game of chance, the game apparatus also being configured to produce a bonus event, wherein steps (A)-(E) occur during the bonus event.

40. A gaming apparatus comprising:
(A) skill game display means for displaying a skill game to a player, the skill game comprising a skill game outcome;
(B) player input means for allowing the player to influence the skill game outcome;
(C) processor means for randomly determining a prize and determining a multiplier, the multiplier comprising the quotient of the prize and the skill game outcome;
(D) multiplier display means for displaying the multiplier to the player.

41. The gaming apparatus of claim 40 wherein the skill game display means comprises a variety of indicator means for displaying indicia to the player and a selection means for selecting an indicator means, the selection means in communication with, and controllable by, the player input means.

42. A method of playing a game comprising, but not necessarily in the order shown:
(A) determining a prize;
(B) allowing a player to use skill to determine a skill game outcome;
(C) dividing the prize by the skill game outcome to determine a multiplier;
(D) rounding the multiplier down to the nearest integer;
(E) calculating the remainder of the prize divided by the skill game outcome;
(F) displaying the multiplier to the player;
(G) awarding the prize to the player, wherein it appears that the prize is the remainder added to the product of the skill game outcome and the multiplier.

43. The method of claim 42, further comprising displaying the remainder to the player.

44. The method of claim 42 wherein the prize is hidden from the player until after the player uses the player's skill to obtain a skill game outcome.

45. The method of claim 42 wherein the prize is independent of the skill game outcome.

46. The method of claim 42 further comprising:
(A) providing a player input device;
(B) allowing a player to manipulate the player input device to influence the skill game outcome.
